(19) United States
(12) Patent Application Publication
(10) Pub. No.: US 2026/0016203 A1
(43) Pub. Date: Jan. 15, 2026

(54) HEAT PUMP MODULE

(71) Applicant: DENSO CORPORATION, Kariya-city (JP)

(72) Inventor: Masashi HIGASHIYAMA, Kariya-city (JP)

(21) Appl. No.: 19/331,001

(22) Filed: Sep. 17, 2025

Related U.S. Application Data
(63) Continuation of application No. PCT/JP2024/009691, filed on Mar. 13, 2024.

(30) Foreign Application Priority Data
Mar. 24, 2023 (JP) 2023-048387

(51) Int. Cl. F25B 30/02; F25B 41/40

(52) U.S. Cl. CPC F25B 30/02; F25B 41/40

(57) ABSTRACT

A compressor compresses and discharges a refrigerant. A component causes refrigerant discharged from the compressor to flow. A flow path forming member is attached with the compressor and the component and defines a refrigerant flow path and a heat medium flow path. The flow path forming member has a high-temperature flow path, a low-temperature flow path, and a heat transfer suppressor. The high-temperature flow path, as one of the refrigerant flow path and the heat medium flow path, causes refrigerant or heat medium exhibiting high temperature due to heat of high-pressure refrigerant. The low-temperature flow path, as one of the refrigerant flow path and the heat medium flow path, causes refrigerant or heat medium exhibiting low temperature. The heat transfer suppressor suppresses transfer of heat between the refrigerant flow path and the heat medium flow path.

### CROSS REFERENCE TO RELATED APPLICATION

The present application is a continuation application of International Patent Application No. PCT/JP2024/009691 filed on Mar. 13, 2024, which designated the U.S. and claims the benefit of priority from Japanese Patent Application No. 2023-048387 filed on Mar. 24, 2023. The entire disclosures of all of the above applications are incorporated herein by reference.

### TECHNICAL FIELD

The present disclosure relates to a heat pump module that integrates at least part of the components of a heat pump cycle device.

### BACKGROUND

Conventionally, a heat pump module including a compressor and various components has been known.

### SUMMARY

According to an aspect of the present disclosure, a heat pump module comprises: a compressor configured to compress and discharge refrigerant; a component being a part of a heat pump cycle and configured to cause refrigerant, which is discharged from the compressor, to flow therethrough; and a flow path forming member to which the compressor and the component are attached, the flow path forming member defining a refrigerant flow path configured to cause refrigerant to flow between the refrigerant flow path and at least one of the compressor or the component, and a heat medium flow path configured to cause heat medium to flow therethrough and to exchange heat with refrigerant in the component. The flow path forming member may include a high-temperature flow path being one of the refrigerant flow path and the heat medium flow path and configured to cause refrigerant or heat medium, which exhibits high temperature due to heat of high-pressure refrigerant, to flow therethrough, a low-temperature flow path being one of the refrigerant flow path and the heat medium flow path and configured to cause refrigerant or heat medium, which exhibits temperature lower than temperature in the high-temperature flow path, to flow therethrough, and a heat transfer suppressor configured to suppress transfer of heat between the refrigerant flow path and the heat medium flow path.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a perspective view showing a heat pump module in a first embodiment;

FIG. 2 is a configuration diagram showing a heat pump system including a heat pump module;

FIG. 3 is a configuration diagram showing an in-cabin air conditioning unit in the heat pump system;

FIG. 4 is a block diagram showing a control system of the heat pump system;

FIG. 5 is a front view showing the heat pump module in the first embodiment;

FIG. 6 is a top view showing the heat pump module in the first embodiment;

FIG. 7 is an explanatory view showing a flow path configuration in a flow path forming member of the heat pump module in the first embodiment; and

FIG. 8 is an explanatory view showing a flow path configuration in the flow path forming member of the heat pump module in a second embodiment.

### DETAILED DESCRIPTION

Hereinafter, examples of the present disclosure will be described.

According to an example of the present disclosure, a heat pump module integrates at least part of the components of a heat pump cycle device. In the heat exchanger, an expansion valve, an accumulator, and other components are integrated with respect to a flow path forming member to configure a module.

Herein, for further downsizing and productivity improvement of the heat pump cycle device, it is desirable to integrate components other than the above. However, when many components are integrated, it is conceivable that the components on a high-temperature side affected by a high-pressure refrigerant and the components on a low-temperature side affected by a low-pressure refrigerant may both be attached to the flow path forming member. In such case, a high-temperature flow path through which a high-temperature fluid flows and a low-temperature flow path through which a low-temperature fluid flows are arranged closely to each other in the flow path forming member.

Also, in recent years, the heat pump cycle device includes, in addition to a heat pump cycle in which a refrigerant circulates, a heat medium circuit in which a heat medium circulates, whose heat amount is adjusted by heat exchange with the refrigerant.

When a heat pump module is applied to such a heat pump cycle device, it is assumed that temperature difference is caused in the flow path forming member, at positions not only between the refrigerant flow paths and the heat medium flow paths, but also between the refrigerant flow path and the heat medium flow path. Since each of the flow paths including the refrigerant flow path and the heat medium flow path is arranged closely to each other in the flow path forming member, heat damage caused by heat transfer between the flow paths may possibly lead to a decrease in a cycle operation efficiency and a decrease in the performance of the heat pump system.

According to an example of the present disclosure, a heat pump module comprises: a compressor configured to compress and discharge refrigerant; a component being a part of a heat pump cycle and configured to cause refrigerant, which is discharged from the compressor, to flow therethrough; and a flow path forming member to which the compressor and the component are attached, the flow path forming member defining a refrigerant flow path configured to cause refrigerant to flow between the refrigerant flow path and at least one of the compressor or the component, and a heat medium flow path configured to cause heat medium to flow therethrough and to exchange heat with refrigerant in the component. The flow path forming member includes a high-temperature flow path being one of the refrigerant flow path and the heat medium flow path and configured to cause refrigerant or heat medium, which exhibits high temperature due to heat of high-pressure refrigerant, to flow therethrough, a low-temperature flow path being one of the refrigerant flow path and the heat medium flow path and configured to cause refrigerant or heat medium, which exhibits temperature lower than temperature in the high-temperature flow path, to flow therethrough, and a heat transfer suppressor configured to suppress transfer of heat between the refrigerant flow path and the heat medium flow path.

According to the heat pump module, the heat pump cycle and a part of the heat medium circuit can be united into the heat pump module, by (i) integrating the compressor, the components, and the flow path forming member into one body, and (ii) forming the refrigerant flow path and the heat medium flow path in the flow path forming member. Further, the heat pump module may possibly have a temperature difference between the refrigerant flow path and the heat medium flow path, because the flow path forming member includes the high-temperature flow path and the low-temperature flow path. The temperature difference between the refrigerant flow path and the heat medium flow path is a source of heat damage in the refrigerant and the heat medium, and may pose a risk of causing performance degradation in the heat pump cycle and/or the heat medium circuit.

However, in such regard, the heat pump module suppresses heat transfer between the refrigerant flow path and the heat medium flow path, by having a heat transfer suppressor formed at a position between the refrigerant flow path and the heat medium flow path in the flow path forming member. Therefore, according to the heat pump module, the heat transfer suppressor can suppress an occurrence of heat damage in the refrigerant and the heat medium, and can prevent the performance degradation of the heat pump cycle and/or the heat medium circuit.

The following describes embodiments for carrying out the present disclosure with reference to the drawings. In each embodiment, parts corresponding to those described in the preceding embodiment are designated by the same reference numerals, and redundant descriptions may be omitted. When only a part of a configuration is described in one embodiment, the other, preceding embodiments may be applied for the other parts of such configuration. The parts may be combined across the embodiment, when explicitly described as combinable or even when not explicitly described so if no hindrance is posed to such combination.

### First Embodiment

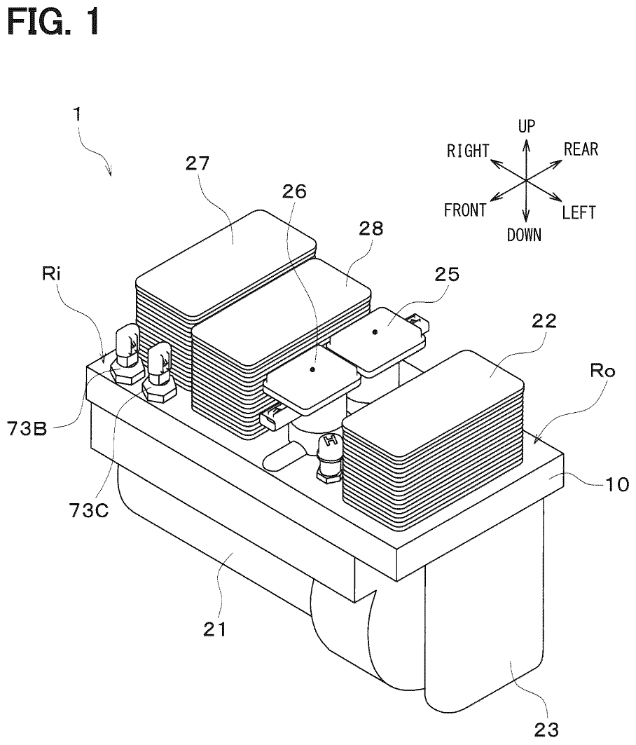

The first embodiment in the present disclosure is described with reference to FIGS. 1 to 7. In the first embodiment, a heat pump module 1 of the present disclosure is applied to a heat pump system 100 installed in an electric vehicle. The electric vehicle is a vehicle that obtains traveling drive force from an electric motor. The heat pump system 100 includes a heat pump cycle 20 and multiple heat medium circuits to air-condition a vehicle cabin, which is a target space to be air conditioned, and to adjust temperature of an onboard device or devices. Therefore, the heat pump system 100 may be called as an air conditioner with an onboard device cooling function, or an onboard device cooling device with an air conditioning function.

More specifically, the heat pump system 100 cools a battery as an onboard device. The battery is a secondary battery that stores electric power supplied to multiple onboard devices operated by electricity. The battery is a battery assembly formed by electrically connecting a plurality of battery cells in a stacked arrangement in series or parallel. The battery cell of the first embodiment is a lithium-ion battery.

The battery generates heat during operation (i.e., during charging and discharging). The battery has the characteristics that its output tends to decrease at low temperatures, and its deterioration tends to progress at high temperatures. Therefore, the battery temperature must be maintained within an appropriate temperature range (in the first embodiment, equal to 15 degrees of Celsius or higher, and equal to 55 degrees of Celsius or lower). Therefore, in the heat pump system 100 of the first embodiment, the battery is cooled when the battery temperature rises.

Therefore, the heat pump system 100 cools the battery by cold heat generated by the heat pump cycle 20. The target of cooling in the heat pump system 100 of the first embodiment is air and the battery.

As shown in FIG. 1, the heat pump module 1 of the first embodiment consists of a plurality of components of the heat pump cycle 20 assembled and integrated into a flat plate-shaped flow path forming member 10. The flow path forming member 10 has a refrigerant flow path and a heat medium flow path formed therein.

In the first embodiment, the components of the heat pump cycle 20 assembled in the flow path forming member 10 include a compressor 21, a heat medium refrigerant heat exchanger 22, a receiver 23, a first expansion valve 25, a second expansion valve 26, a first chiller 27, and a second chiller 28. By assembling the components of the heat pump cycle 20, including the compressor 21, onto the flow path forming member 10, a part of the configuration of the heat pump system 100 can be modularized.

In the heat pump module 1, the arrangement of each of the components with respect to the flow path forming member 10 and each of the flow paths formed in an inside of the flow path forming member 10 will be explained later in detail with reference to the drawings.

In the following explanation, directions of front-rear, left-right, upper and lower are defined as shown by the arrows in FIG. 1, assuming that a longitudinal direction of the heat pump module 1 (i.e., the longitudinal direction of the flow path forming member 10) extending to the left and right is used as a reference. The same definitions are used for the arrows shown in each of the drawings as appropriate.

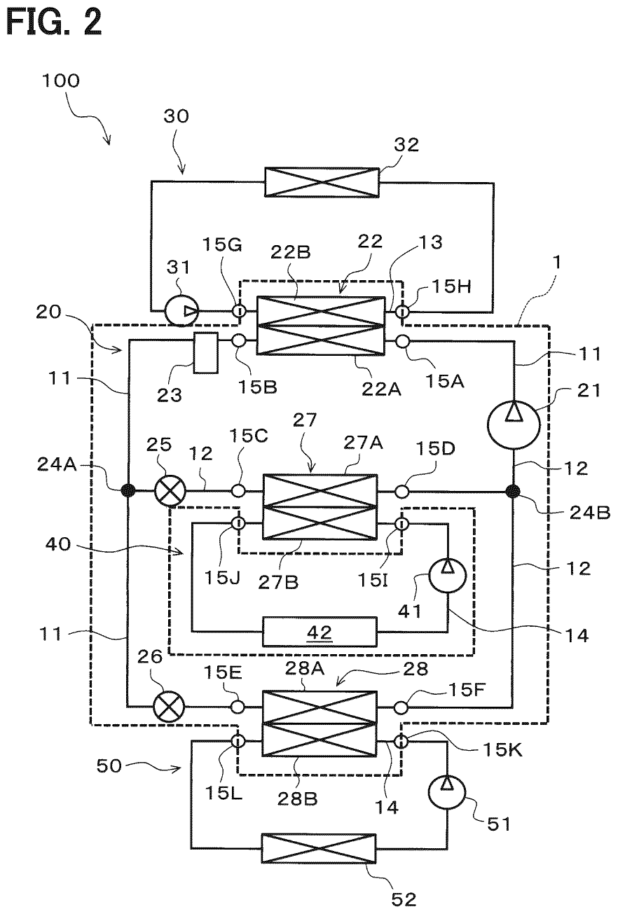

Next, the schematic configuration of the heat pump system 100 including the heat pump module 1 of the first embodiment will be described with reference to the drawings. Note that, in FIG. 2, part of the heat pump system 100 that is configured by the heat pump module 1 of the first embodiment is encompassed by a broken line.

As shown in FIG. 2, the heat pump system 100 of the first embodiment consists of the heat pump cycle 20, a high-temperature heat medium circuit 30, a first low-temperature heat medium circuit 40, and a second low-temperature heat medium circuit 50. Further, the heat pump system 100 includes (a) an in-cabin air-conditioning unit 60 for supplying conditioned air, which is temperature-controlled by using the hot and cold heat generated by the heat pump cycle 20, and (b) a controller 70 for controlling each of the configurations of the heat pump system 100.

First, the configuration of the heat pump cycle 20 in the heat pump system 100 is described. The heat pump cycle 20 is a vapor compression type refrigerator with the compressor 21, the heat medium refrigerant heat exchanger 22, the receiver 23, the first expansion valve 25, the second expansion valve 26, the first chiller 27, and the second chiller 28.

The heat pump cycle 20 of the first embodiment uses a Freon type refrigerant, and constitutes a subcritical refrigeration cycle in which a high-pressure side refrigerant pressure does not exceed a critical pressure of the refrigerant. The refrigerant is mixed with a refrigerator oil to lubricate the compressor 21. A part of the refrigerator oil circulates in the cycle together with the refrigerant.

The compressor 21 is an electric compressor driven by electric power, which sucks in, compresses, and discharges the refrigerant that circulates in the heat pump cycle 20. The compressor 21 contains a compression mechanism 21B that compresses the vapor-phase refrigerant in the heat pump cycle 20 and a drive unit 21C for operating the compression mechanism 21B, in an inside of a housing 21A formed substantially in a cylinder shape. As shown in FIG. 1, the compressor 21 of the first embodiment forms part of the heat pump module 1, and is attached to a bottom surface of the flat plate-shaped flow path forming member 10.

An outlet port of the compressor 21 is connected to a refrigerant inlet port of the heat medium refrigerant heat exchanger 22 via a high-pressure flow path 11 and a first connector 15A formed as a refrigerant flow path in the flow path forming member 10. Here, the high-pressure flow path 11 is a flow path through which the high-pressure refrigerant discharged from the compressor 21 in the heat pump cycle 20 flows. Therefore, the high-pressure flow path 11 corresponds to an example of a refrigerant flow path, and at the same time, corresponds to an example of a high-temperature flow path. That is, the high-pressure flow path 11 corresponds to a high-temperature refrigerant flow path.

The heat medium refrigerant heat exchanger 22 has a refrigerant passage 22A for flowing the high-pressure refrigerant discharged from the compressor 21, and a heat medium passage 22B for flowing a high-temperature heat medium circulating in the high-temperature heat medium circuit 30.

The heat medium refrigerant heat exchanger 22 is a condenser that condenses the high-pressure refrigerant circulating in the refrigerant passage 22A, by exchanging heat with the high-temperature heat medium circulating in the heat medium passage 22B. That is, the heat medium refrigerant heat exchanger 22 dissipates heat possessed by the high-pressure refrigerant discharged from the compressor 21 to the high-temperature heat medium circulating in the high-temperature heat medium circuit 30, thereby heating the high-temperature heat medium. The heat medium refrigerant heat exchanger 22 of the first embodiment forms part of the heat pump module 1, and is attached to a top surface of the flow path forming member 10.

The receiver 23 is connected to the refrigerant outlet port of the heat medium refrigerant heat exchanger 22 via the high-pressure flow path 11 and a second connector 15B formed in the flow path forming member 10. The receiver 23 is a gas-liquid separator that separates the gas-liquid of the refrigerant flowing out of the refrigerant passage 22A of the heat medium refrigerant heat exchanger 22 to flow the liquid phase refrigerant toward downstream and to store excess refrigerant from the cycle. The receiver 23 of the first embodiment forms part of the heat pump module 1, and is attached to the bottom surface of the flow path forming member 10.

A refrigerant branch 24A is connected to the outlet port of the receiver 23. In the refrigerant branch 24A, one of the three inlet-outlet ports is used as a refrigerant inlet port, and the other two are used as refrigerant outlet ports. In other words, the refrigerant branch 24A is a branch that divides the flow of liquid-phase refrigerant flowing out of the receiver 23.

The refrigerant inlet port of the first expansion valve 25 is connected to one of the refrigerant outlet ports of the refrigerant branch 24A via the high-pressure flow path 11 of the flow path forming member 10. Further, the refrigerant inlet port of the second expansion valve 26 is connected to the other one of the refrigerant outlet ports of the refrigerant branch 24A via the high-pressure flow path 11 of the flow path forming member 10.

The first expansion valve 25 is a decompression unit that decompresses and expands the liquid phase refrigerant that flows out of one of the outlet ports of the refrigerant branch 24A. The first expansion valve 25 is an electric variable throttle mechanism, and includes a valve plug and an electric actuator. The valve plug is configured to change the degree of opening of the refrigerant flow path (in other words, the throttle opening degree). The electric actuator includes a stepping motor that changes a throttle opening degree of the valve body.

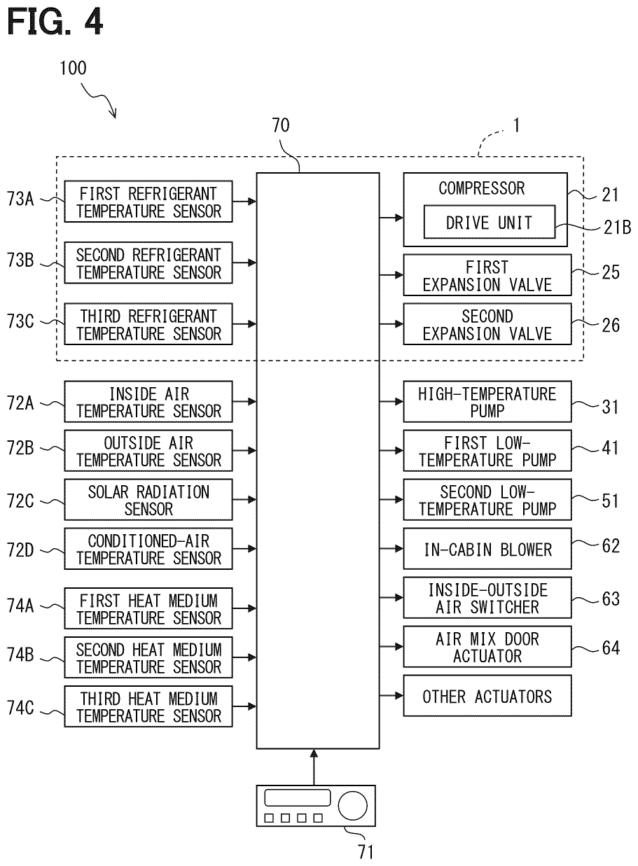

The first expansion valve 25 consists of a variable throttle mechanism with a total close function that totally closes the flow path of the refrigerant. The first expansion valve 25 of the first embodiment forms part of the heat pump module 1, and is attached to the top surface of the flow path forming member 10. The operation of the first expansion valve 25 is controlled by a control signal output from the controller 70 shown in FIG. 4.

The refrigerant inlet port of the first chiller 27 is connected to the refrigerant outlet port of the first expansion valve 25 via a low-pressure flow path 12 and a third connector 15C of the flow path forming member 10. Here, the low-pressure flow path 12 is a flow path through which the low-pressure refrigerant decompressed in the decompression unit such as the first expansion valve 25 or the like flows. Therefore, the low-pressure flow path 12 corresponds to an example of a refrigerant flow path, and at the same time, corresponds to an example of a low-temperature flow path. That is, the low-pressure flow path 12 corresponds to the low-temperature refrigerant flow path.

The first chiller 27 includes a refrigerant passage 27A for flowing the low-pressure refrigerant decompressed by the first expansion valve 25, and a heat medium passage 27B for flowing the low-temperature heat medium circulating in the first low-temperature heat medium circuit 40. The first chiller 27 is an evaporator that exchanges heat between the low-pressure refrigerant circulating in the refrigerant passage 27A and the low-temperature heat medium circulating in the heat medium passage 27B to evaporate the low-pressure refrigerant and to exert its endothermic effect.

A refrigerant merge unit 24B is connected to the outlet port of the refrigerant passage 27A in the first chiller 27 via the low-pressure flow path 12 and a fourth connector 15D of the flow path forming member 10. In the refrigerant merge unit 24B, two of the three inlet-outlet ports are used as the refrigerant inlet ports and the remaining one is used as the refrigerant outlet port. In other words, the refrigerant merge unit 24B is a merge unit that merges the refrigerant flows branched at the refrigerant branch 24A.

As shown in FIG. 2, a second expansion valve 26 is connected to the other refrigerant outlet of the refrigerant branch 24A. The second expansion valve 26 is a decompression unit that decompresses and expands the liquid phase refrigerant flowing out of the other outlet port of the refrigerant branch 24A. The second expansion valve 26, like the first expansion valve 25, is configured to change the degree of opening of the refrigerant flow path (in other words, the throttle opening).

The second expansion valve 26 is composed of a variable throttle mechanism with a total closing function that totally closes the flow path of the refrigerant. The second expansion valve 26 of the first embodiment forms part of the heat pump module 1. The second expansion valve 26 is attached to a top surface of the flow path forming member 10, and is arranged adjacent to the first expansion valve 25 in the heat pump module 1. The operation of the second expansion valve 26 is controlled by a control signal output from the controller 70.

The refrigerant inlet port of the second chiller 28 is connected to the refrigerant outlet port of the second expansion valve 26 via the low-pressure flow path 12 and a fifth connector 15E of the flow path forming member 10. The second chiller 28 includes a refrigerant passage 28A for flowing the low-pressure refrigerant decompressed by the second expansion valve 26 and a heat medium passage 28B for flowing the low-temperature heat medium circulating in the second low-temperature heat medium circuit 50. The second chiller 28 is an evaporator that exchanges heat between the low-pressure refrigerant circulating in the refrigerant passage 28A and the low-temperature heat medium circulating in the heat medium passage 28B to evaporate the low-pressure refrigerant and to exert its endothermic effect.

The refrigerant merge unit 24B is connected to the outlet port of the refrigerant passage 28A in the second chiller 28 via the low-pressure flow path 12 and a sixth connector 15F of the flow path forming member 10. Thus, the refrigerant merge unit 24B merges the flow of refrigerant flowing out of the first chiller 27 with the flow of refrigerant flowing out of the second chiller 28. Then, the outlet port of the refrigerant merge unit 24B is connected to the inlet port of the compressor 21 via the low-pressure flow path 12 of the flow path forming member 10.

Note that, in the heat pump cycle 20 of the first embodiment, the refrigerant is compressed by the compressor 21 to boost the pressure, and then decompressed by the first expansion valve 25 or the second expansion valve 26 before being sucked into the compressor 21. Therefore, the refrigerant flow path from the outlet port of the compressor 21 to the inlet port of the first expansion valve 25 or the second expansion valve 26 can be called as a high-pressure flow path. The refrigerant flow path from the outlet port of the first expansion valve 25 or the second expansion valve 26 to the inlet port of the compressor 21 can be called as a low-pressure flow path.

Next, the high-temperature heat medium circuit 30 of the heat pump system 100 is described. The high-temperature heat medium circuit 30 is a circuit that circulates the high-temperature heat medium. The high-temperature heat medium circuit 30 uses ethylene glycol solution as the high-temperature heat medium. The high-temperature heat medium circuit 30 is provided with the heat medium passage 22B of the heat medium refrigerant heat exchanger 22, a high-temperature pump 31, and a heater core 32.

Note that the high-temperature heat medium can be any fluid that is capable of transferring heat generated by the heat medium refrigerant heat exchanger 22, and various forms of heat medium are useable. For example, a liquid containing at least ethylene glycol, dimethylpolysiloxane or nanofluid, or an antifreeze body can be employed as the high-temperature heat medium.

The high-temperature pump 31 is a heat medium pump in the high-temperature heat medium circuit 30 that sucks in and pumps the high-temperature heat medium. The outlet port of the high-temperature pump 31 is connected to the inlet port of the heat medium passage 22B in the heat medium refrigerant heat exchanger 22 via the high-temperature heat medium flow path 13 and a seventh connector 15G in the flow path forming member 10.

Thus, the high-temperature pump 31 pumps the high-temperature heat medium to the inlet port of the heat medium passage 22B of the heat medium refrigerant heat exchanger 22. The high-temperature pump 31 is an electric water pump whose speed (i.e., pumping capacity) is controlled by a control voltage output from the controller 70.

Here, the high-temperature heat medium flow path 13 is a flow path in the flow path forming member 10, through which the high-temperature heat medium in the high-temperature heat medium circuit 30 flows. That is, the high-temperature heat medium flow path 13 corresponds to an example of a heat medium flow path and at the same time corresponds to an example of a high-temperature flow path.

The outlet port of the heat medium passage 22B in the heat medium refrigerant heat exchanger 22 is connected to the heat medium inlet port of the heater core 32 via the high-temperature heat medium flow path 13 and an eighth connector 15H of the flow path forming member 10. The heater core 32 is arranged in a casing 61 of the in-cabin air-conditioning unit 60, as described later, and is a heating heat exchanger that exchanges heat between the high-temperature heat medium heated by the heat medium refrigerant heat exchanger 22 and the blown air. In the heater core 32, heat possessed by the high-temperature heat medium is dissipated to the blown air to heat the blown air. The inlet port of the high-temperature pump 31 is connected to the heat medium outlet port of the heater core 32.

Therefore, in the heat pump system 100 of the first embodiment, each of the components of the heat medium refrigerant heat exchanger 22 and the high-temperature heat medium circuit 30 can heat the conditioned air by using the high-pressure refrigerant discharged from the compressor 21 as a heat source to heat the blown air.

The first low-temperature heat medium circuit 40, which constitutes the heat pump system 100, is described next. The first low-temperature heat medium circuit 40 is a circuit that circulates the low-temperature heat medium. In the first low-temperature heat medium circuit 40, the same type of fluid as the high-temperature heat medium is employed as the low-temperature heat medium. The first low-temperature heat medium circuit 40 has the heat medium passage 27B of the first chiller 27, a first low-temperature pump 41, and a battery heat exchanger 42 respectively arranged therein.

The first low-temperature pump 41 is a heat medium pump that sucks in and pumps the low-temperature heat medium circulating in the first low-temperature heat medium circuit 40. The outlet port of the first low-temperature pump 41 is connected to the inlet port of the heat medium passage 27B in the first chiller 27 via a low-temperature heat medium flow path 14 and a ninth connector 15I of the flow path forming member 10.

Therefore, the first low-temperature pump 41 pumps the low-temperature heat medium to the inlet port of the heat medium passage 27B in the first chiller 27. The first low-temperature pump 41 is an electric water pump whose speed (i.e., pumping capacity) is controlled by the control voltage output from the controller 70.

Here, the low-temperature heat medium flow path 14 is a flow path in the flow path forming member 10, through which the low-temperature heat medium circulating in the first low-temperature heat medium circuit 40 or in the second low-temperature heat medium circuit 50 flows. That is, the low-temperature heat medium flow path 14 corresponds to an example of a heat medium flow path and at the same time corresponds to an example of a low-temperature flow path.

The outlet port of the heat medium passage 27B in the first chiller 27 is connected to the heat medium inlet port of the battery heat exchanger 42 via the low-temperature heat medium flow path 14 and a tenth connector 15J of the flow path forming member 10. The battery heat exchanger 42 is a heat exchanger that exchanges heat between a plurality of battery cells constituting the battery and the low-temperature heat medium. The battery heat exchanger 42 consists of a flow path in which the low-temperature heat medium is circulated in a battery case housing the multiple battery cells. Further, the inlet port of the first low-temperature pump 41 is connected to the heat medium outlet port of the battery heat exchanger 42.

Thus, in the heat pump system 100 of the first embodiment, each of the components of the first chiller 27 and the first low-temperature heat medium circuit 40 can realize a temperature control function to adjust the battery temperature.

Next, the second low-temperature heat medium circuit 50, which constitutes the heat pump system 100, is described. The second low-temperature heat medium circuit 50 is a circuit that circulates the low-temperature heat medium. In the second low-temperature heat medium circuit 50, the same type of fluid as the high-temperature heat medium can be employed as the low-temperature heat medium. The second low-temperature heat medium circuit 50 has the heat medium passage 28B of the second chiller 28, a second low-temperature pump 51, and a cooler core 52 arranged therein.

The second low-temperature pump 51 is a heat medium pump that sucks in and pumps the low-temperature heat medium circulating in the second low-temperature heat medium circuit 50. The outlet port of the second low-temperature pump 51 is connected to the inlet port of the heat medium passage 28B in the second chiller 28 via the low-temperature heat medium flow path 14 and an eleventh connector 15K in the flow path forming member 10. Thus, the second low-temperature pump 51 pumps the low-temperature heat medium to the inlet port of the heat medium passage 28B in the second chiller 28. The second low-temperature pump 51 is an electric water pump whose speed (i.e., pumping capacity) is controlled by the control voltage output from the controller 70.

The outlet port of the heat medium passage 28B in the second chiller 28 is connected to the heat medium inlet port in the cooler core 52 via the low-temperature heat medium flow path 14 and a twelfth connector 15L in the flow path forming member 10. The cooler core 52 is a cooling heat exchanger that cools the blown air by exchanging heat between the low-temperature heat medium circulating in the second low-temperature heat medium circuit 50 and the blown air supplied to the vehicle cabin, which is a target space of air-conditioning. The cooler core 52 is arranged inside the in-cabin air-conditioning unit 60, which is described later, and absorbs heat from the blown air blown into the vehicle cabin to the low-temperature heat medium. Therefore, the cooler core 52 corresponds to an example of a cooling section that has the blown air as a cooling target. The inlet port of the second low-temperature pump 51 is connected to the heat medium outlet port of the cooler core 52.

Thus, in the heat pump system 100 of the first embodiment, each of the components of the second chiller 28 and the second low-temperature heat medium circuit 50 can cool the blown air by using the low-pressure refrigerant decompressed by the second expansion valve 26 as a cooling heat source.

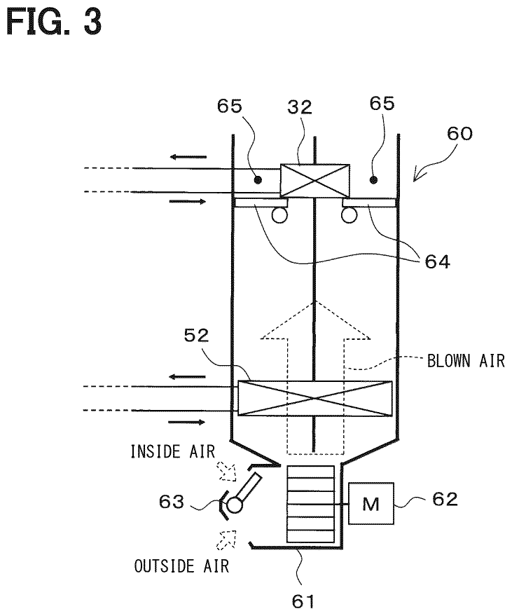

Next, the in-cabin air-conditioning unit 60 of the heat pump system 100 is described with reference to FIG. 3. The in-cabin air-conditioning unit 60 is a unit that integrates a number of components in order to blow temperature-adjusted conditioned air to an appropriate position in the vehicle cabin, for air-conditioning the vehicle cabin in an electric vehicle. The in-cabin air-conditioning unit 60 is arranged inside an instrument panel at a front-most position of the vehicle cabin in the electric vehicle.

The in-cabin air-conditioning unit 60 is formed by housing an in-cabin blower 62, the cooler core 52, the heater core 32, and other components in the casing 61 that forms an air passage for the blown air. The casing 61 is molded from a resin (e.g., polypropylene) that has a certain degree of elasticity and excellent strength.

An inside-outside air switcher 63 is arranged at the most upstream side of the flow of blown air in the casing 61. The inside-outside air switcher 63 switches and introduces inside air (i.e., in-cabin air) and outside air (i.e., outside-cabin air) into the casing 61. The operation of the inside-outside air switcher 63 is controlled by a control signal output from the controller 70.

The in-cabin blower 62 is arranged downstream of the flow of blown air at the inside-outside air switcher 63. The in-cabin blower 62 blows air that has been sucked in through the inside-outside air switcher 63 into the vehicle cabin. The speed (i.e., blowing capacity) of the in-cabin blower 62 is controlled by the control voltage output from the controller 70.

The cooler core 52 and the heater core 32 are arranged downstream of the flow of blown air of the in-cabin blower 62, in the written order relative to the flow of blown air. In other words, the cooler core 52 is arranged upstream of the flow of blown air than the heater core 32. A cold air bypass passage 65 is formed in the casing 61 to allow the blown air after passing through the cooler core 52 to bypass the heater core 32.

In the casing 61, an air mix door 64 is arranged (a) downstream of the flow of blown air from the cooler core 52 and (b) upstream of the flow of blown air of the heater core 32 and the cold air bypass passage 65. The air mix door 64 adjusts a ratio between (a) an airflow rate of the blown air that passes through the heater core 32 and (b) an airflow rate of the blown air that passes through the cold air bypass passage 65, among the blown air that has passed through the cooler core 52. The operation of a drive unit of the air mix door 64 is controlled by a control signal output from the controller 70.

A mixing space is arranged downstream of the flow of blown air from the heater core 32 and the cold air bypass passage 65. The mixing space is a space for mixing (i) the blown air heated by the heater core 32 and (ii) the unheated blown air that has passed through the cold air bypass passage 65. Therefore, in the in-cabin air-conditioning unit 60, temperature of the blown air (i.e., conditioned air) mixed in the mixing space adjustable by adjusting the opening degree of the air mix door 64.

Multiple opening holes are formed in a downstream-most part of the flow of blown air of the casing 61 to blow out the conditioned air toward various positions in the vehicle cabin. Multiple opening holes respectively have, arranged thereto, a blowout mode door that opens and closes each opening hole. The operation of a blowout mode door drive unit is controlled by a control signal output from the controller 70. Therefore, the in-cabin air-conditioning unit 60 can blow out, to an appropriate position in the vehicle cabin, conditioned air which has appropriately-adjusted temperature by switching the opening holes that are opened and closed by the blowout mode door.

According to the heat pump system 100 configured in the above-described manner, air conditioning of the vehicle cabin and temperature adjustment of the onboard devices are appropriately performable by controlling the operation of the heat pump cycle 20, the high-temperature heat medium circuit 30, the first low-temperature heat medium circuit 40, and the second low-temperature heat medium circuit 50.

Next, an electric controller of the heat pump system 100 is outlined with reference to FIG. 4. The controller 70 consists of a well-known microcomputer including a CPU, ROM, RAM, and the like, together with peripheral circuits. The controller 70 performs various calculations and processing based on a control program stored in ROM, and controls the operation of various control target devices connected to an output side thereof. The controller 70 corresponds to an example of a control unit.

Various control target devices include the compressor 21, the first expansion valve 25, the second expansion valve 26, the high-temperature pump 31, the first low-temperature pump 41, the second low-temperature pump 51, the in-cabin blower 62, the inside-outside air switcher 63, the air mix door 64, and the like. Regarding the above, a control instruction from the controller 70 is transmitted to the heat pump module 1, because the compressor 21, the first expansion valve 25, and the second expansion valve 26 are the components of the heat pump module 1.

Further, various control sensors are connected to an input side of the controller 70, as shown in FIG. 4. As control sensors, an inside air temperature sensor 72A, an outside air temperature sensor 72B, a solar radiation sensor 72C, and a conditioned-air temperature sensor 72D are connected. Further, a first refrigerant temperature sensor 73A, a second refrigerant temperature sensor 73B, a third refrigerant temperature sensor 73C, a first heat medium temperature sensor 74A, a second heat medium temperature sensor 74B, and a third heat medium temperature sensor 74C are also connected as the control sensors.

Further, the inside air temperature sensor 72A is an inside air temperature detector that detects an inside air temperature Tr, which is temperature of the vehicle cabin. The outside air temperature sensor 72B is an outside temperature detector that detects an outside air temperature Tam, which is temperature outside the vehicle cabin. The solar radiation sensor 72C is a solar radiation amount detector that detects a solar radiation amount As irradiated into the vehicle cabin. The conditioned-air temperature sensor 72D is a conditioned-air temperature detector that detects a blown air temperature TAV blown from the mixing space into the vehicle cabin.

The first refrigerant temperature sensor 73A is a refrigerant temperature detector that detects temperature of the high-pressure refrigerant discharged from the compressor 21. The first refrigerant temperature sensor 73A is arranged, for example, at the inlet port in the refrigerant passage 22A of the heat medium refrigerant heat exchanger 22.

The second refrigerant temperature sensor 73B detects temperature of the low-pressure refrigerant flowing out of the first chiller 27. The second refrigerant temperature sensor 73B is arranged, for example, at the outlet port in the refrigerant passage 27A of the first chiller 27.

The third refrigerant temperature sensor 73C detects temperature of the low-pressure refrigerant flowing out of the second chiller 28. The third refrigerant temperature sensor 73C is arranged, for example, at the outlet port in the refrigerant passage 28A of the second chiller 28.

Then, the first to third refrigerant temperature sensors 73A to 73C are assembled to the heat pump module 1, and the detection results by each of those sensors are output from the heat pump module 1 to the controller 70.

As for control sensors, the sensors assembled to the heat pump module 1 are not limited to the first refrigerant temperature sensor 73A to the third refrigerant temperature sensor 73C. A refrigerant pressure sensor that detects a pressure of the refrigerant circulating in the heat pump cycle 20 may be arranged as a control sensor to be assembled in the heat pump module 1. In such case, a configuration in which multiple refrigerant pressure sensors are assembled to the heat pump module 1 may be adopted.

The first heat medium temperature sensor 74A is a heat medium temperature detector that detects temperature of the high-temperature heat medium circulating in the high-temperature heat medium circuit 30. The first heat medium temperature sensor 74A is arranged, for example, at the outlet port of the heat medium passage 22B in the heat medium refrigerant heat exchanger 22.

The second heat medium temperature sensor 74B is a heat medium temperature detector that detects temperature of the low-temperature heat medium circulating in the first low-temperature heat medium circuit 40. The second heat medium temperature sensor 74B is arranged, for example, at the outlet port of the heat medium passage 27B in the first chiller 27.

The third heat medium temperature sensor 74C is a heat medium temperature detector that detects temperature of the low-temperature heat medium circulating in the second low-temperature heat medium circuit 50. The third heat medium temperature sensor 74C is arranged, for example, at the outlet port of the heat medium passage 28B in the second chiller 28.

Note that the flow path forming member 10 of the heat pump module 1 has a part of the heat medium flow path that constitutes the high-temperature heat medium circuit 30, the first low-temperature heat medium circuit 40, and the second low-temperature heat medium circuit 50. Therefore, the heat pump module 1 may have the first heat medium temperature sensor 74A to the third heat medium temperature sensor 74C integrated thereto as a control sensor, to realize a sensor-integrated heat pump module 1, which has a configuration in which the sensors and other components are provided in one body.

Further, the input side of the controller 70 is connected to an operation panel 71 arranged near the instrument panel at the front of the vehicle cabin in the electric vehicle. The controller 70 receives operation signals from the various operation switches on the operation panel 71.

The various operation switches on the operation panel 71 include, specifically, an auto switch, an air conditioner switch, an airflow setting switch, a temperature setting switch, and the like. The auto switch is an operation switch that sets or cancels an automatic control operation of the heat pump cycle 20.

The air conditioner switch is an operation switch that requests the cooler core 52 to cool the blown air. The airflow setting switch is an operation switch used to manually set an airflow rate of the in-cabin blower 62. The temperature setting switch is an operation switch to set a target temperature Tset of the vehicle cabin.

The controller 70 of the first embodiment is an integral part of the control units for controlling various control target devices connected to its output side. Therefore, a configuration for controlling the operation of each of the control target devices (i.e., hardware and software) serves as a control unit that controls the operation of each of the control target devices.

For example, the configuration of the controller 70 that controls a refrigerant discharge capacity (e.g., rotation speed) of the compressor 21 in the heat pump cycle 20 corresponds to a compressor control unit. Further, the configuration of the controller 70 that controls an amount of decompression (i.e., throttle opening degree) at the first expansion valve 25 and the second expansion valve 26 of the heat pump cycle 20 corresponds to a decompression control unit.

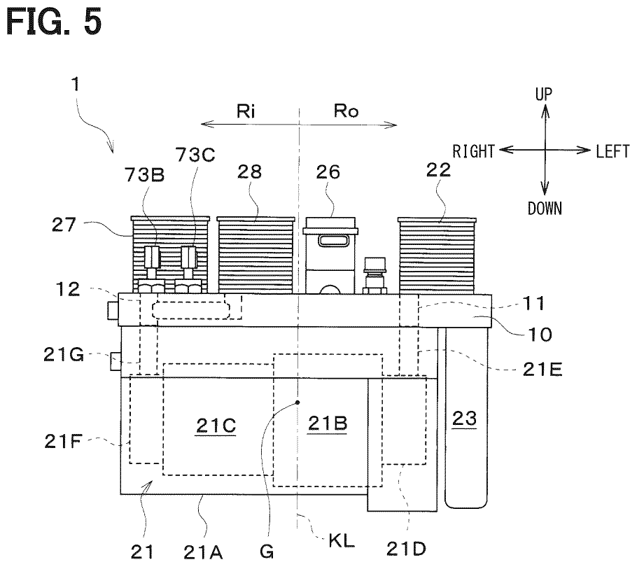

The specific configuration of the heat pump module 1 of the first embodiment is then described with reference to FIGS. 5 to 7. As described above, the heat pump module 1 consists of (i) a flat plate-shape flow path forming member 10 attached to a top surface of the compressor 21 and (ii) multiple components in the heat pump cycle 20 attached to the flow path forming member 10.

First, the configuration of the compressor 21, which constitutes the heat pump module 1, is described. As shown in FIG. 5, the compressor 21 includes the housing 21A, the compressor 21, the compression mechanism 21B, an outlet port 21D, an outlet flow path 21E, an inlet port 21F, and an inlet flow path 21G.

The compressor 21 houses, in an inside of the housing 21A that is formed substantially in a cylinder shape, the compression mechanism 21B that compresses the gas-phase refrigerant in the heat pump cycle 20 and the drive unit 21C for operating the compression mechanism 21B.

For example, a fixed-capacity type compression mechanism with a fixed discharge capacity may be adopted as the compression mechanism 21B. As for the specific mechanism of the compression mechanism 21B, various types of compression mechanisms can be employed as long as the mechanism is capable of sucking in refrigerant, compressing it, and discharging it.

The drive unit 21C is composed of an electric motor, for example, and generates a driving force to operate the compression mechanism 21B. The drive unit 21C is arranged alongside the compression mechanism 21B in the longitudinal direction of the housing 21A having a substantially-cylindrical shape. As shown in FIG. 5, the compression mechanism 21B is arranged on a left side in the housing 21A of the compressor 21, and the drive unit 21C is arranged adjacent thereto, i.e., on a right side of the compression mechanism 21B.

Further, the compressor 21 has, formed thereon, the outlet port 21D, the outlet flow path 21E, the inlet port 21F, and the inlet flow path 21G. The outlet port 21D is composed of (a) an outlet port from which the high-pressure refrigerant compressed by the compression mechanism 21B is discharged and (b) an outlet chamber related to the refrigerant discharged from the outlet port. The outlet port 21D is arranged on a left side of the compression mechanism 21B in an inside of the housing 21A, for example.

The outlet flow path 21E is a refrigerant flow path that leads the high-pressure refrigerant discharged through the outlet port 21D to an outside of the compressor 21, and is formed in the housing 21A. An end of the outlet flow path 21E is connected to the high-pressure flow path 11 formed in the flow path forming member 10. Therefore, the outlet flow path 21E is connected to the inlet port of the refrigerant passage 22A of the heat medium refrigerant heat exchanger 22 via the high-pressure flow path 11 and the first connector 15A of the flow path forming member 10.

The inlet port 21F is composed of (a) an inlet port through which the low-pressure refrigerant, which is a target of compression in the compression mechanism 21B, is sucked in, and (b) an inlet chamber related to the low-pressure refrigerant led to the inlet port. The inlet port 21F is arranged, for example, in an inside of the housing 21A, on a right side of the drive unit 21C.

The inlet flow path 21G is a refrigerant flow path formed in the housing 21A that leads the low-pressure refrigerant flowing through the low-pressure flow path 12 of the flow path forming member 10 to the inlet port 21F in an inside of the compressor 21. An end of the inlet flow path 21G is connected to (a) the outlet port in the refrigerant passage 27A of the first chiller 27 and (b) the outlet port in the refrigerant passage 28A of the second chiller 28 via the low-pressure flow path 12, the fourth connector 15D and the sixth connector 15F of the flow path forming member 10.

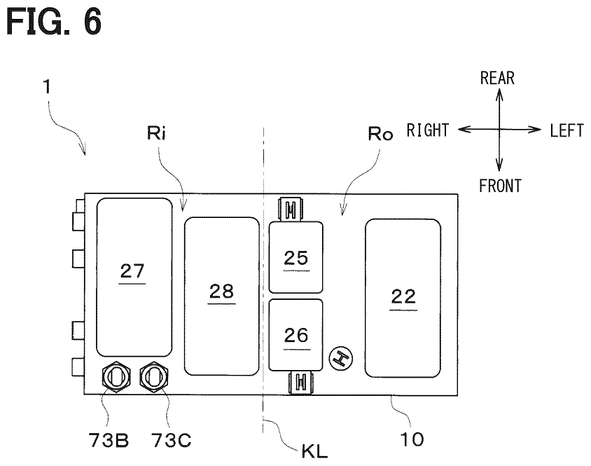

As shown in FIGS. 5 and 6, each of the components of the heat pump module 1 is arranged so that the center of gravity of the heat pump module 1 is not greatly biased with respect to the position of the center of gravity of the compressor 21 (hereinafter referred to as a compressor gravity center G).

Further, the flow path forming member 10 to which each of the components of the heat pump module 1 is attached has, defined therein, an outlet region Ro and an inlet region Ri. The outlet region Ro and the inlet region Ri in the flow path forming member 10 are defined by the relative positions of the compressor 21 and the flow path forming member 10, respectively constituting the heat pump module 1.

Specifically, the outlet region Ro and the inlet region Ri in the flow path forming member 10 are arranged adjacent to each other on the left and right side of a reference line KL which is defined based on the compressor gravity center G, when viewed from one side of a flat surface that constitutes the top surface of the flow path forming member 10.

The reference line KL is defined to pass through the compressor gravity center G, which is the position of the center of gravity of the compressor 21 when viewed from a position in the vertical direction relative to the flat surface of the flow path forming member 10 in the heat pump module 1. The reference line KL in the first embodiment is defined as a straight line extending in a front-rear direction through the compressor gravity center G.

Note that the outlet region Ro and the inlet region Ri, which are divided by the reference line KL, spread in the vertical direction, i.e., including above and below of the flat surface of the flow path forming member 10, not necessarily restricted to the surface of the flow path forming member 10. Therefore, the heat pump module 1 is divided into the outlet region Ro and the inlet region Ri by a reference plane that includes the reference line KL passing through the compressor gravity center G and extending in the vertical direction.

The outlet region Ro of the flow path forming member 10 is arranged on one side (left side in the drawing) relative to the reference line KL in the flow path forming member 10. As described later, in the outlet region Ro of the flow path forming member 10, the high-pressure flow path 11 in which the high-pressure refrigerant in the heat pump cycle 20 flows is arranged. Since the high-pressure flow path 11 is connected to the outlet port 21D of the compressor 21, the outlet region Ro of the flow path forming member 10 can be described as part of the flow path forming member 10 that is arranged on an outlet port 21D side of the compressor 21, and exhibits high temperature as the refrigerant is compressed and high-pressure refrigerant flows therein.

Further, the inlet region Ri of the flow path forming member 10 is arranged on the other side (right side in the drawing) of the reference line KL in the flow path forming member 10. The low-pressure flow path 12 in which the low-pressure refrigerant in the heat pump cycle 20 flows is arranged in the inlet region Ri of the flow path forming member 10. Since the low-pressure flow path 12 is connected to the inlet port 21F of the compressor 21, the inlet region Ri of the flow path forming member 10 can be described as part of the flow path forming member 10 arranged on an inlet port 21F side of the compressor 21, and shows lower temperature than the outlet region Ro as the low-pressure refrigerant flows therein.

As shown in FIGS. 5 and 6, the heat medium refrigerant heat exchanger 22, the receiver 23, the first expansion valve 25, and the second expansion valve 26 are attached to the outlet region Ro side of the flow path forming member 10 in the heat pump module 1 as components. The heat medium refrigerant heat exchanger 22, the receiver 23, the first expansion valve 25, and the second expansion valve 26 are components of the heat pump cycle 20 into which the high-pressure refrigerant in the heat pump cycle 20 flows. Therefore, the heat medium refrigerant heat exchanger 22, the receiver 23, the first expansion valve 25, and the second expansion valve 26 correspond to an example of a high-pressure refrigeration device.

The heat medium refrigerant heat exchanger 22 is a heat exchanger that functions as a condenser in the heat pump cycle 20, as described above. As shown in FIGS. 5 and 6, the heat medium refrigerant heat exchanger 22 is attached to the leftmost position on the top surface of the flow path forming member 10, and is arranged in the outlet region Ro.

Further, the heat medium refrigerant heat exchanger 22 includes the refrigerant passage 22A and the heat medium passage 22B. The refrigerant passage 22A of the heat medium refrigerant heat exchanger 22 is connected to the high-pressure flow path 11 formed in the flow path forming member 10 via each of the first connector 15A and the second connector 15B of the flow path forming member 10.

The inlet port in the heat medium passage 22B of the heat medium refrigerant heat exchanger 22 is connected to the outlet port of the high-temperature pump 31 via the high-temperature heat medium flow path 13 and the seventh connector 15G formed in the flow path forming member 10. Also, the outlet port in the heat medium passage 22B of the heat medium refrigerant heat exchanger 22 is connected to the heat medium inlet port of the heater core 32 via the high-temperature heat medium flow path 13 and the eighth connector 15H formed in the flow path forming member 10.

The receiver 23 is a gas-liquid separator that separates the gas-liquid of the refrigerant flowing out of the heat medium refrigerant heat exchanger 22 to flow the liquid-phase refrigerant toward downstream and to store excess refrigerant from the cycle. As shown in FIGS. 5 and 6, the receiver 23 is attached to the leftmost position (i.e., to the left of the compressor 21) on the bottom surface of the flow path forming member 10, and is arranged in the outlet region Ro.

The first expansion valve 25 is a decompression unit that reduces the pressure of the high-pressure refrigerant flowing out of one of the refrigerant outlet ports of the refrigerant branch 24A. The first expansion valve 25 corresponds to an example of the high-pressure refrigeration device in the first embodiment, because the high-pressure refrigerant flows thereinto. The first expansion valve 25 is arranged on the top surface of the flow path forming member 10, next to, i.e., on a right side of, the heat medium refrigerant heat exchanger 22, which is a position close to a rear in the front-rear direction.

As shown in FIG. 6, the first expansion valve 25 is arranged close to the reference line KL in the outlet region Ro in the flow path forming member 10. The inlet port of the first expansion valve 25 is connected to the outlet port in the receiver 23 via the high-pressure flow path 11 formed in the flow path forming member 10. Also, the outlet port of the first expansion valve 25 is connected to the inlet port in the refrigerant passage 27A of the first chiller 27 via the low-pressure flow path 12 and the third connector 15C of the flow path forming member 10.

The second expansion valve 26 is a decompression unit that reduces the pressure of the high-pressure refrigerant flowing out of the other refrigerant outlet port of the refrigerant branch 24A. The second expansion valve 26 corresponds to an example of the high-pressure refrigeration device in the first embodiment because the high-pressure refrigerant flows thereinto. The second expansion valve 26 is arranged on the top surface of the flow path forming member 10, next to, i.e., on a right side of, the heat medium refrigerant heat exchanger 22, and adjacent to, i.e., on a front side of, the first expansion valve 25.

As shown in FIG. 6, the second expansion valve 26 is arranged at a position (a) close to the reference line KL in the outlet region Ro and (b) in front of the first expansion valve 25, in the outlet region Ro in the flow path forming member 10. The inlet port of the second expansion valve 26 is connected to the outlet port in the receiver 23 via the high-pressure flow path 11 formed in the flow path forming member 10. Also, the outlet port of the second expansion valve 26 is connected to the inlet port in the refrigerant passage 28A of the second chiller 28 via the low-pressure flow path 12 and the fifth connector 15E of the flow path forming member 10.

On the other hand, the first chiller 27 and the second chiller 28 are attached to an inlet region Ri side of the flow path forming member 10 in the heat pump module 1 as the components. The first chiller 27 and the second chiller 28 are the components of the heat pump cycle 20 through which the low-pressure refrigerant in the heat pump cycle 20 flows. Therefore, the first chiller 27 and the second chiller 28 correspond to an example of the low-pressure refrigeration device.

The first chiller 27 is a heat exchanger that functions as an evaporator in the heat pump cycle 20, as described above. As shown in FIGS. 5 and 6, the first chiller 27 is attached to the rightmost position on the top surface of the flow path forming member 10, and is arranged in the inlet region Ri.

Further, the first chiller 27 includes the refrigerant passage 27A and the heat medium passage 27B. The inlet port in the refrigerant passage 27A of the first chiller 27 is connected to the low-pressure flow path 12 formed in the flow path forming member 10 via the third connector 15C of the flow path forming member 10. Then, the outlet port in the refrigerant passage 27A of the first chiller 27 is connected to an inlet port 21F side of the compressor 21 via the low-pressure flow path 12 and the fourth connector 15D formed in the flow path forming member 10.

Also, the inlet port in the heat medium passage 27B of the first chiller 27 is connected to the outlet port of the first low-temperature pump 41 via the low-temperature heat medium flow path 14 and the ninth connector 15I formed in the flow path forming member 10. Then, the outlet port in the heat medium passage 27B of the first chiller 27 is connected to the heat medium inlet port in the battery heat exchanger 42 via the low-temperature heat medium flow path 14 and the tenth connector 15J formed in the flow path forming member 10.

The second chiller 28, just like the first chiller 27, is a heat exchanger that functions as an evaporator in the heat pump cycle 20. As shown in FIGS. 5 and 6, the second chiller 28 is attached to the top surface of the flow path forming member 10, adjacently on a left side of the first chiller 27, and is arranged in the inlet region Ri.

Then, the second chiller 28 includes the refrigerant passage 28A and the heat medium passage 28B. The inlet port in the refrigerant passage 28A of the second chiller 28 is connected to the low-pressure flow path 12 formed in the flow path forming member 10 via the fifth connector 15E of the flow path forming member 10. Then, the outlet port in the refrigerant passage 28A of the second chiller 28 is connected to an inlet port 21F side of the compressor 21 via the low-pressure flow path 12 and the sixth connector 15F formed in the flow path forming member 10.

Also, the inlet port of the heat medium passage 28B of the second chiller 28 is connected to the outlet port of the second low-temperature pump 51 via the low-temperature heat medium flow path 14 and the eleventh connector 15K formed in the flow path forming member 10. Then, the outlet port in the heat medium passage 28B of the second chiller 28 is connected to the heat medium inlet port in the cooler core 52 via the low-temperature heat medium flow path 14 and the twelfth connector 15L formed in the flow path forming member 10.

As shown in FIG. 5, a relative position of the compressor 21 and the flow path forming member 10 is defined so that the compression mechanism 21B of the compressor 21 is positioned on an outlet region Ro side and the drive unit 21C of the compressor 21 is positioned on an inlet region Ri side. By arranging each of the components of the heat pump module 1 in a manner shown in FIGS. 5 and 6, a balance of the weights can be achieved between the outlet region Ro and the inlet region Ri.

That is, the heat pump module 1 can be configured without the center of gravity of the heat pump module 1 being shifted significantly away from the center of gravity of the compressor 21 (i.e., the compressor gravity center G) either toward the outlet port or toward the inlet port. Therefore, the heat pump module 1 is prevented from suffering from a low attachability, in terms of attachment thereof to the other device (electric vehicles in the first embodiment).

Further, in the heat pump module 1 of the first embodiment, the high-pressure refrigeration devices such as the heat medium refrigerant heat exchanger 22, the receiver 23, the first expansion valve 25, and the second expansion valve 26 are arranged on an outlet region Ro side of the flow path forming member 10. Since all of these high-pressure refrigeration devices are the components into which the high-pressure refrigerant exhibiting high temperature flows, a temperature range associated with each of the high-pressure refrigeration devices is also relatively high.

Therefore, by providing the united arrangement of the high-pressure refrigeration devices in the heat pump cycle 20 on the outlet region Ro side in the flow path forming member 10, the temperature ranges of the high-pressure refrigeration devices can be brought closer to each other. In such manner, according to the heat pump module 1, the high-pressure refrigeration devices united in the outlet region Ro of the flow path forming member 10 prevent heat damage among the high-pressure refrigeration devices.

Also, in the heat pump module 1, the low-pressure refrigeration devices such as the first chiller 27 and the second chiller 28 are arranged on an inlet region Ri side of the flow path forming member 10. Since these low-pressure refrigerant devices are the components through which the low-pressure refrigerant indicating low temperature flows, the temperature range of each of the component is also relatively low.

Therefore, by providing the united arrangement the low-pressure refrigeration devices in the heat pump cycle 20 on the inlet region Ri side of the flow path forming member 10, the temperature ranges of the low-pressure refrigeration devices can be brought closer to each other. According to the above, the heat pump module 1 can prevent heat damage among the low-pressure refrigeration devices by devising the united arrangement of the low-pressure refrigeration devices on the inlet region Ri side in the flow path forming member 10.

Further, on the top surface of the flow path forming member 10, the first expansion valve 25 and the second expansion valve 26 are arranged at a position between (a) the high-pressure refrigeration device and (b) the low-pressure refrigeration device, i.e., between (a) the heat medium refrigerant heat exchanger 22 and (b) the first chiller 27 and the second chiller 28.

Each of the first expansion valve 25 and the second expansion valve 26 is a device (a) into which the high-pressure refrigerant flowing out of the refrigerant branch 24A flows, and at the same time, (b) out of which the decompressed, low-pressure refrigerant flows. Therefore, the first expansion valve 25 and the second expansion valve 26 are considered to exhibit a temperature range closer to that of the low-pressure refrigeration device than the temperature range of the heat medium refrigerant heat exchanger 22 and the receiver 23, among the high-pressure refrigeration devices.

As shown in FIG. 5, by arranging the first expansion valve 25 and the second expansion valve 26 at a position between (a) the heat medium refrigerant heat exchanger 22 and (b) the first and second chillers 27 and 28, heat damage caused between the heat medium refrigerant heat exchanger 22 and the first and second chillers 27 and 28 is suppressible.

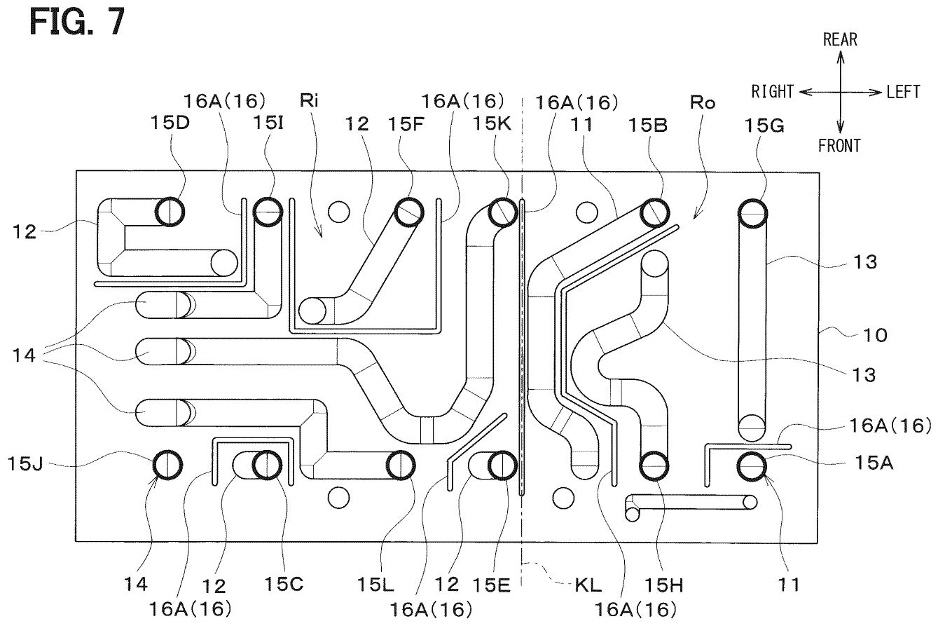

The specific configuration of the flow path forming member 10 in the heat pump module 1 is then described with reference to FIG. 7. As mentioned above, the flow path forming member 10 is formed in a flat plate-shape, and includes a refrigerant flow path in the heat pump cycle 20 and part of the heat medium flow paths in the high-temperature heat medium circuit 30, the first low-temperature heat medium circuit 40, and the second low-temperature heat medium circuit 50. Further, the flow path forming member 10 has, formed therein, a heat transfer suppressor 16 to suppress heat transfer between the refrigerant flow path and the heat medium flow path.

The heat transfer suppressor 16 of the first embodiment is composed of a slit 16A formed in the flow path forming member 10. The slit 16A is arranged at a position between the refrigerant flow path and the heat medium flow path, around either one of the refrigerant flow path or the heat medium flow path, and has a hollow internal space. Since the internal space of the slit 16A is filled with air, which has a lower thermal conductivity than the constituent material of the flow path forming member 10, heat transfer between the refrigerant flow path and the heat medium flow path can be inhibited by interposing the slit 16A between the refrigerant flow path and the heat medium flow path.

The formation range of the slit 16A in the vertical direction (i.e., thickness direction) of the flow path forming member 10 may preferably be wider than the range of the refrigerant flow path and the heat medium flow path formed in the flow path forming member 10. This is because the slit 16A ensures that the transfer of heat between the refrigerant flow path and the heat medium flow path is inhibited by the slit 16A, thereby suppressing heat damage.

As shown in FIG. 7, the high-pressure flow path 11 and the high-temperature heat medium flow path 13 are formed in the outlet region Ro of the flow path forming member 10. Specifically, in the outlet region Ro of the flow path forming member 10, as the high-pressure flow path 11, the high-pressure flow path 11 extending from the first connector 15A and the high-pressure flow path 11 extending from the second connector 15B are formed. Also, in the outlet region Ro of the flow path forming member 10, as the high-temperature heat medium flow paths 13, the high-temperature heat medium flow path 13 extending from the seventh connector 15G and the high-temperature heat medium flow path 13 extending from the eighth connector 15H are formed.

In the heat pump cycle 20 of the first embodiment, heat from the high-pressure refrigerant flowing in the refrigerant passage 22A is dissipated to the high-temperature heat medium flowing in the heat medium passage 22B in heat medium refrigerant heat exchanger 22. Therefore, the temperature indicated by the high-pressure refrigerant is higher than that indicated by the high-temperature heat medium.

The high-pressure flow path 11 extending from the first connector 15A is formed in the outlet region Ro of the flow path forming member 10, and is arranged on the front side at the left end of the flow path forming member 10. The high-temperature heat medium flow path 13 extending from the seventh connector 15G is formed in the outlet region Ro of the flow path forming member 10, and is arranged in a straight line extending from the rear side toward the front along the left end of the flow path forming member 10.

Here, the slit 16A as the heat transfer suppressor 16 is formed in the right part and the rear part of the high-pressure flow path 11 extending from the first connector 15A. The slit 16A is arranged at a position between the high-pressure flow path 11 extending from the first connector 15A and the high-temperature heat medium flow path 13 extending from the seventh connector 15G, which are arranged in the front-rear direction. In such manner, heat damage between the high-pressure flow path 11 extending from the first connector 15A and the high-temperature heat medium flow path 13 extending from the seventh connector 15G, which are arranged in the front-rear direction, is suppressible.

Specifically, according to the heat pump module 1, the temperature of the high-pressure refrigerant flowing in the high-pressure flow path 11 extending from the first connector 15A can be suppressed from lowering due to the effect of heat from the high-temperature heat medium flowing in the high-temperature heat medium flow path 13 pertaining to the seventh connector 15G. Similarly, according to the heat pump module 1, the temperature of the high-temperature heat medium flowing in the high-temperature heat medium flow path 13 pertaining to the seventh connector 15G can be suppressed from rising due to the effect of heat from the high-pressure refrigerant flowing in the high-pressure flow path 11 pertaining to the first connector 15A.

Also, in the outlet region Ro of the flow path forming member 10, on a right side of the high-pressure flow path 11 extending from the first connector 15A, the high-temperature heat medium flow path 13 extending from the eighth connector 15H is formed. The high-temperature heat medium flow path 13 extending from the eighth connector 15H extends from front to rear on the right side of the high-pressure flow path 11 extending from the first connector 15A and the high-temperature heat medium flow path 13 extending from the seventh connector 15G.

As shown in FIG. 7, the slit 16A is formed in the right side part of the high-pressure flow path 11 extending from the first connector 15A, i.e., at a position between the high-pressure flow path 11 and the high-temperature heat medium flow path 13 extending from the eighth connector 15H. In such manner, the generation of heat damage between the high-pressure flow path 11 pertaining to the first connector 15A and the high-temperature heat medium flow path 13 pertaining to the eighth connector 15H, which are arranged side by side in the right and left directions in the outlet region Ro of the flow path forming member 10, is suppressible.

Further, in the outlet region Ro of the flow path forming member 10, the second connector 15B is formed on the right side of the seventh connector 15G and behind the high-temperature heat medium flow path 13 extending from the eighth connector 15H. The high-pressure flow path 11 extending from the second connector 15B is formed to extend behind the high-temperature heat medium flow path 13 pertaining to the eighth connector 15H toward the reference line KL, and to extend forward between the high-temperature heat medium flow path 13 pertaining to the eighth connector 15H and the reference line KL.

Here, the slit 16A as the heat transfer suppressor 16 is formed at a position between the high-pressure flow path 11 extending from the second connector 15B and the high-temperature heat medium flow path 13 extending from the eighth connector 15H. Specifically, the slit 16A is formed along the high-pressure flow path 11 on the right side of the high-pressure flow path 11 extending from the second connector 15B. In such manner, heat damage between the high-pressure flow path 11 extending from the second connector 15B and the high-temperature heat medium flow path 13 extending from the eighth connector 15H, which are arranged next to each other, is suppressible.

Thus, a part of the high-pressure flow path 11 and a part of the high-temperature heat medium flow path 13 in the heat pump module 1 are united in the outlet region Ro of the flow path forming member 10. In the heat pump module 1 of the first embodiment, a part of the high-pressure flow path 11 and a part of the high-temperature heat medium flow path 13 formed in the outlet region Ro of the flow path forming member 10 are considered to belong to the same temperature range, thereby suppressing heat damage caused between fluid flow paths formed in the outlet region Ro.

Also, in the outlet region Ro of the flow path forming member 10, the slit 16A as the heat transfer suppressor 16 is formed at a position between the high-pressure flow path 11 and the high-temperature heat medium flow path 13. In such manner, the influence of heat between the high-pressure refrigerant flowing in the high-pressure flow path 11 and the high-temperature heat medium flowing in the high-temperature heat medium flow path 13 is mitigated, thereby suppressing the occurrence of heat damage between the high-pressure flow path 11 and the high-temperature heat medium flow path 13.

As shown in FIG. 7, the low-pressure flow path 12 and the low-temperature heat medium flow path 14 are formed in the inlet region Ri of the flow path forming member 10. Specifically, the low-pressure flow path 12 extending from the third connector 15C and the low-pressure flow path 12 extending from the fourth connector 15D are formed, as the low-pressure flow path 12 in the inlet region Ri of the flow path forming member 10. Further, in the inlet region Ri, the low-pressure flow path 12 extending from the fifth connector 15E and the low-pressure flow path 12 extending from the sixth connector 15F are formed.

Also, as the low-temperature heat medium flow paths 14 in the inlet region Ri of the flow path forming member 10, the low-temperature heat medium flow path 14 extending from the ninth connector 15I and the low-temperature heat medium flow path 14 extending from the tenth connector 15J are formed. Further, in the inlet region Ri, the low-temperature heat medium flow path 14 extending from the eleventh connector 15K and the low-temperature heat medium flow path 14 extending from the twelfth connector 15L are formed.

Note that, in the heat pump cycle 20 of the first embodiment, heat from the low-temperature heat medium flowing in the heat medium passage is absorbed by the low-pressure refrigerant flowing in the refrigerant passage in the first chiller 27 or the second chiller 28. Therefore, the temperature indicated by the low-pressure refrigerant is lower than that indicated by the low-temperature heat medium.

The fifth connector 15E is formed in the inlet region Ri of the flow path forming member 10 in the front part on a reference line KL side (i.e., left side). The low-pressure flow path 12 extending from the fifth connector 15E is formed to extend in the right direction from the fifth connector 15E.

The eleventh connector 15K is formed in the rear part on a reference line KL side (i.e., left side) in the inlet region Ri of the flow path forming member 10, the low-temperature heat medium flow path 14 extending from the eleventh connector 15K is formed to extend from the rear to the front and then to the right. Thus, a part of the low-temperature heat medium flow path 14 extending from the eleventh connector 15K is adjacent to the low-pressure flow path 12 extending from the fifth connector 15E.

Here, in the flow path forming member 10 of the heat pump module 1 of the first embodiment, the slit 16A as the heat transfer suppressor 16 is formed along the reference line KL. As shown in FIG. 7, the low-pressure flow path 12 pertaining to the fifth connector 15E and the low-temperature heat medium flow path 14 pertaining to the eleventh connector 15K formed in the inlet region Ri are adjacent to the high-pressure flow path 11 pertaining to the second connector 15B formed in the outlet region Ro, across the reference line KL.

By forming the slit 16A along the reference line KL between the outlet region Ro and the inlet region Ri, heat damage between the high-pressure flow path 11 pertaining to the second connector 15B and the low-temperature flow path 12 pertaining to the fifth connector 15E is suppressible. Also, in the heat pump module 1, heat damage between the high-pressure flow path 11 pertaining to the second connector 15B and the low-temperature heat medium flow path 14 pertaining to the eleventh connector 15K is suppressible.

Further, in the inlet region Ri of the flow path forming member 10, the slit 16A as the heat transfer suppressor 16 is formed on the right side and rear side of the low-pressure flow path 12 pertaining to the fifth connector 15E. As shown in FIG. 7, the low-pressure flow path 12 pertaining to the fifth connector 15E is adjacent to the low-temperature heat medium flow path 14 pertaining to the eleventh connector 15K via the slit 16A with respect to the rear side of the flow path forming member 10. In such manner, the generation of heat damage between the low-pressure flow path 12 pertaining to the fifth connector 15E and the low-temperature heat medium flow path 14 pertaining to the eleventh connector 15K, which are arranged side by side in the right and left directions in the inlet region Ri of the flow path forming member 10, is suppressible.

Specifically, according to the heat pump module 1, the temperature of the low-pressure refrigerant flowing in the low-pressure flow path 12 extending from the fifth connector 15E can be suppressed from rising due to the effect of heat from the low-temperature heat medium flowing in the low-temperature heat medium flow path 14 pertaining to the eleventh connector 15K. Similarly, according to the heat pump module 1, the temperature of the low-temperature heat medium flowing in the low-temperature heat medium flow path 14 pertaining to the eleventh connector 15K can be suppressed from lowering due to the effect of heat from the low-pressure refrigerant flowing in the low-pressure flow path 12 pertaining to the fifth connector 15E.

The twelfth connector 15L is formed on a right side of the fifth connector 15E, on the front side of the inlet region Ri in the flow path forming member 10. The low-temperature heat medium flow path 14 extending from the twelfth connector 15L is formed to extend from the twelfth connector 15L to the right side, and has a crank-shaped bend in the middle of the flow path extending to the right side. The low-temperature heat medium flow path 14 extending from the twelfth connector 15L is arranged in front of a rightward extending part of the low-temperature heat medium flow path 14 extending from the eleventh connector 15K, and is adjacent to a part of the low-temperature heat medium flow path 14 extending from the eleventh connector 15K.

The sixth connector 15F is formed in the inlet region Ri of the flow path forming member 10, at a position to the right of the eleventh connector 15K and behind the twelfth connector 15L. The low-pressure flow path 12 extending from the sixth connector 15F is arranged to the right as it extends forward from the sixth connector 15F. A part of the low-pressure flow path 12 extending from the sixth connector 15F is adjacent to and behind the low-temperature heat medium flow path 14 extending from the eleventh connector 15K.

As shown in FIG. 7, the slit 16A as a heat transfer suppressor 16 is formed around the low-pressure flow path 12 extending from the sixth connector 15F. The slit 16A is arranged on the front and left side of the low-pressure flow path 12 pertaining to the sixth connector 15F, to interpose between the low-pressure flow path 12 and the low-temperature heat medium flow path 14 extending from the eleventh connector 15K. Therefore, the generation of heat damage between the low-pressure flow path 12 pertaining to the sixth connector 15F and the low-temperature heat medium flow path 14 pertaining to the eleventh connector 15K, which are arranged side by side in the inlet region Ri of the flow path forming member 10, is suppressible.

The third connector 15C is formed on the right side of the twelfth connector 15L and in the front part of the inlet region Ri in the flow path forming member 10. The low-pressure flow path 12 extending from the third connector 15C is adjacent to and on the front side of the low-temperature heat medium flow path 14 extending from the twelfth connector 15L, and extends in the right direction.

The ninth connector 15I is formed in the inlet region Ri of the flow path forming member 10, at a position on the right side of the twelfth connector 15L and behind the third connector 15C. The low-temperature heat medium flow path 14 extending from the ninth connector 15I is formed to extend forward from the ninth connector 15I and then toward the right.

On the rear and left side of the low-pressure flow path 12 pertaining to the third connector 15C, the slit 16A is formed to interpose between the low-temperature heat medium flow path 14 and the twelfth connector 15L as a heat transfer suppressor 16. Therefore, in the inlet region Ri of the flow path forming member 10, the generation of heat damage between the low-pressure flow path 12 pertaining to the third connector 15C and the low-temperature heat medium flow path 14 pertaining to the twelfth connector 15L is suppressible.

A part of the low-temperature heat medium flow path 14 extending from the ninth connector 15I is adjacent to a part of the low-pressure flow path 12 extending from the sixth connector 15F in the left-right direction. Also, a part of the low-temperature heat medium flow path 14 extending from the ninth connector 15I extends to the right along a part of the low-temperature heat medium flow path 14 extending from the eleventh connector 15K, and is adjacent to and behind the low-temperature heat medium flow path 14 extending from the eleventh connector 15K.

As shown in FIG. 7, the slit 16A formed around the low-pressure flow path 12 pertaining to the sixth connector 15F interposes, on the right side of the low-pressure flow path 12 pertaining to the sixth connector 15F, at a position between the low-pressure flow path 12 and the low-temperature heat medium flow path 14 pertaining to the ninth connector 15I. In such manner, the occurrence of heat damage between the low-pressure flow path 12 pertaining to the sixth connector 15F and the low-temperature heat medium flow path 14 pertaining to the ninth connector 15I is suppressible in the inlet region Ri of the flow path forming member 10.

The tenth connector 15J is formed on the right side of the third connector 15C in the front part of the inlet region Ri in the flow path forming member 10. The low-temperature heat medium flow path 14 extending from the tenth connector 15J is adjacent to and on the right side of the low-pressure flow path 12 extending from the third connector 15C. Further, the low-temperature heat medium flow path 14 extending from the tenth connector 15J is adjacent to and in front of the low-temperature heat medium flow path 14 extending from the twelfth connector 15L.

Here, a part of the slit 16A formed around the low-pressure flow path 12 pertaining to the third connector 15C extends to interpose between the low-pressure flow path 12 and the low-temperature heat medium flow path 14 pertaining to the tenth connector 15J. That is, the slit 16A can suppress the occurrence of heat damage between the low-pressure flow path 12 pertaining to the third connector 15C and the low-temperature heat medium flow path 14 pertaining to the tenth connector 15J.

The fourth connector 15D is formed in the inlet region Ri of the flow path forming member 10, at a position on the right side of the ninth connector 15I and behind the tenth connector 15J. That is, the fourth connector 15D is formed at the right rear corner part in the inlet region Ri of the flow path forming member 10. The low-pressure flow path 12 extending from the fourth connector 15D is formed to extend from the fourth connector 15D to the right, then to the front, and then to the left. The low-pressure flow path 12 extending from the fourth connector 15D is adjacent to a part of the low-temperature heat medium flow path 14 extending from the ninth connector 15I, because the low-pressure flow path 12 is behind the low-temperature heat medium flow path 14 extending from the ninth connector 15I.

On the right side of the ninth connector 15I, the slit 16A is formed as the heat transfer suppressor 16. The slit 16A is formed along the low-temperature heat medium flow path 14 extending from the ninth connector 15I, on the right side thereof, i.e., of the low-temperature heat medium flow path 14. Thus, the slit 16A arranged on the right side of the low-temperature heat medium flow path 14 pertaining to the ninth connector 15I is interposed between the low-temperature heat medium flow path 14 and the low-pressure flow path 12 pertaining to the fourth connector 15D. In such manner, the occurrence of heat damage between the low-pressure flow path 12 pertaining to the fourth connector 15D and the low-temperature heat medium flow path 14 pertaining to the ninth connector 15I in the inlet region Ri of the flow path forming member 10 is suppressible.

As shown in FIG. 7, a part of the low-pressure flow path 12 and a part of the low-temperature heat medium flow path 14 in the heat pump module 1 are united and arranged in the inlet region Ri of the flow path forming member 10. In the heat pump module 1, a part of the low-pressure flow path 12 and a part of the low-temperature heat medium flow path 14 formed in the inlet region Ri of the flow path forming member 10 are considered to belong to the same temperature range, thereby suppressing heat damage caused between fluid flow paths formed in the inlet region Ri.

Also, the slit 16A, serving as a heat transfer suppressor 16, is formed at a position between the low-pressure flow path 12 and the low-temperature heat medium flow path 14 in the inlet region Ri. In such manner, the slit 16A inhibiting heat transfer between the low-pressure flow path 12 and the low-temperature heat medium flow path 14 can more reliably suppress heat damage between the low-pressure flow path 12 and the low-temperature heat medium flow path 14.

As explained above, the heat pump module 1 of the first embodiment includes the compressor 21, the components such as the heat medium refrigerant heat exchanger 22, and the flow path forming member 10. The flow path forming member 10 has, formed therein, (a) the refrigerant flow paths consisting of the high-pressure flow path 11 and the low-pressure flow path 12 and (b) the heat medium flow paths consisting of the high-temperature heat medium flow path 13 and the low-temperature heat medium flow path 14, as well as having the compressor 21 and the components attached thereto.

As shown in FIG. 7, it can also be understood that the flow path forming member 10 has, formed therein, (a) the high-temperature flow path consisting of the high-pressure flow path 11 and the high-temperature heat medium flow path 13 and (b) the low-temperature flow path consisting of the low-pressure flow path 12 and the low-temperature heat medium flow path 14. Here, the slit 16A is formed in the flow path forming member 10 as the heat transfer suppressor 16, suppressing heat transfer between the refrigerant flow path and the heat medium flow path.

Therefore, according to the heat pump module described above, by integrating the components such as the compressor 21, the heat medium refrigerant heat exchanger 22 and the like and the flow path forming member 10 in one body, and by forming the refrigerant flow paths and the heat medium flow paths in the flow path forming member 10, a part of the heat pump cycle 20 and a part of the heat medium circuit are united.

Further, in the heat pump module 1, a temperature difference may occur between the refrigerant flow path and the heat medium flow path, because the high-temperature flow path and the low-temperature flow path are formed in the flow path forming member 10. The temperature difference between the refrigerant flow path and the heat medium flow path is a source of heat damage in the refrigerant and the heat medium, and may cause performance degradation in the heat pump cycle 20 and/or the heat medium circuit.

In this regard, in the heat pump module 1, the slit 16A is formed at a position between the refrigerant flow path and the heat medium flow path in the flow path forming member 10 as the heat transfer suppressor 16 to suppress heat transfer between the refrigerant flow path and the heat medium flow path. Therefore, according to the heat pump module 1, the heat transfer suppressor 16 can suppress the occurrence of heat damage in the refrigerant and the heat medium, thereby preventing the performance degradation of the heat pump cycle and/or the heat medium circuit.

As shown in FIG. 7, the flow path forming member 10 of the heat pump module 1 of the first embodiment has, formed therein, the slit 16A as the heat transfer suppressor 16 between the multiple refrigerant flow paths and the multiple heat medium flow paths.

For example, in the flow path forming member 10, the slit 16A as the heat transfer suppressor 16 is formed at a position between the high-pressure flow path 11 extending from the second connector 15B and the high-temperature heat medium flow path 13 extending from the eighth connector 15H.

In the heat pump system 100, the temperature of the high-pressure refrigerant flowing in the high-pressure flow path 11 is considered to be higher than the temperature of the high-temperature heat medium flowing in the high-temperature heat medium flow path 13, because the high-temperature heat medium is heated by the heat of the high-pressure refrigerant in the heat medium refrigerant heat exchanger 22. Therefore, by forming the slit 16A at a position between the high-pressure flow path 11 and the high-temperature heat medium flow path 13, heat transfer between the high-pressure flow path 11 and the high-temperature heat medium flow path 13 is suppressible, and the performance degradation of the heat pump cycle 20 and the high-temperature heat medium circuit 30 due to heat damage is suppressible.

Then, in the flow path forming member 10, the slit 16A as the heat transfer suppressor 16 is formed at a position between the low-pressure flow path 12 extending from the fourth connector 15D and the low-temperature heat medium flow path 14 extending from the ninth connector 15I.

In the heat pump system 100, the temperature of the low-pressure refrigerant flowing in the low-pressure flow path 12 is considered to be lower than the temperature of the low-temperature heat medium flowing in the low-temperature heat medium flow path 14, because the heat of the low-temperature heat medium is absorbed by the low-pressure refrigerant in the first chiller 27 or in the second chiller 28. Therefore, by forming the slit 16A at a position between the low-pressure flow path 12 and the low-temperature heat medium flow path 14, heat transfer between the low-pressure flow path 12 and the low-temperature heat medium flow path 14 is suppressible. In such manner, the heat pump module 1 is prevented from having the performance degradation regarding the heat pump cycle 20, the first low-temperature heat medium circuit 40, and the second low-temperature heat medium circuit 50 due to heat damage.

As shown in FIG. 7, the slit 16A as the heat transfer suppressor 16 is formed at a position between the high-pressure flow path 11 extending from the second connector 15B and the low-temperature heat medium flow path 14 extending from the eleventh connector 15K in the flow path forming member 10.

Here, with respect to the temperature difference between the fluids in the refrigerant flow path and the heat medium flow path, the temperature difference between the high-pressure refrigerant flowing in the high-pressure flow path 11 and the low-temperature heat medium flowing in the low-temperature heat medium flow path 14 is relatively large. In other words, it is understood that, in terms of heat damage between the refrigerant flow path and the heat medium flow path, heat damage caused between the high-pressure flow path 11 and the low-temperature heat medium flow path 14 has significant influence.

In the heat pump module 1 of the first embodiment, heat transfer between the high-pressure flow path 11 and the low-temperature heat medium flow path 14 is suppressed by the slit 16A. As a result, the heat pump module 1 can securely prevent that the performance of the heat pump cycle 20 and the second low-temperature heat medium circuit 50 is degraded by heat damage.

### Second Embodiment

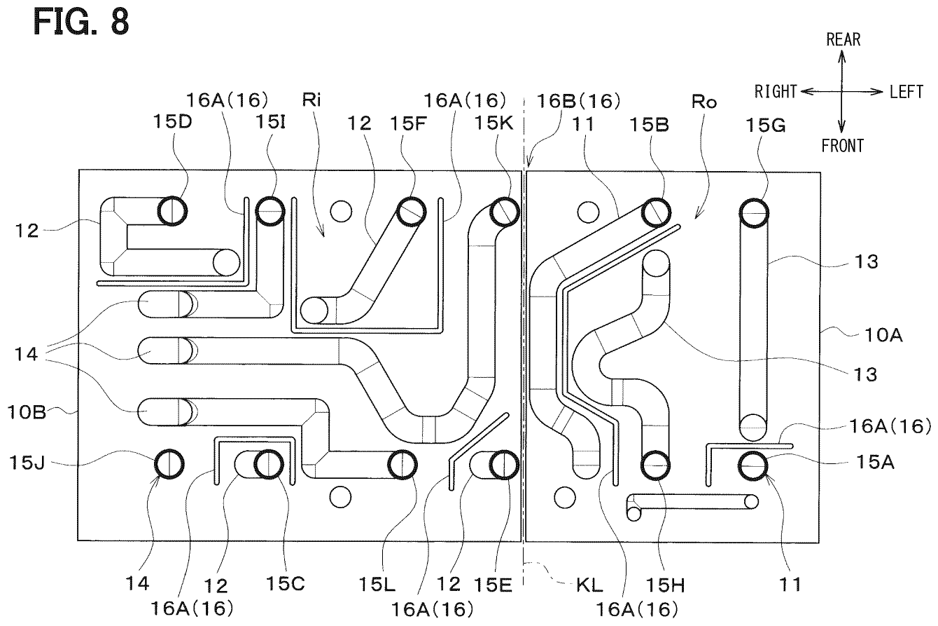

Next, the second embodiment, which differs from the embodiment described above, is explained with reference to FIG. 8. In the heat pump module 1 of the second embodiment, the configuration of the flow path forming member 10 and the heat transfer suppressor 16 differs from the first embodiment described above. Other configurations in the second embodiment (e.g., configuration of the heat pump system 100, details of each of the components in the compressor 21 and the heat pump module 1) are the same as in the first embodiment described above, and therefore will not be described again.

As in the first embodiment, the heat pump module 1 of the second embodiment constitutes a part of the heat pump cycle 20 and the heat medium circuits such as the high-temperature heat medium circuit 30, the first low-temperature heat medium circuit 40, and the second low-temperature heat medium circuit 50. The heat pump module 1 of the second embodiment consists of the compressor 21, the heat medium refrigerant heat exchanger 22, the receiver 23, the first expansion valve 25, the second expansion valve 26, the first chiller 27, and the second chiller 28 assembled to the flat plate-shaped flow path forming member 10.

Here, as shown in FIG. 8, in the heat pump module 1 of the second embodiment, the flow path forming member 10 is composed of a first flow path forming member 10A and a second flow path forming member 10B. In the second embodiment, the first flow path forming member 10A and the second path forming member 10B correspond to the flow path forming member 10 of the first embodiment divided into two parts with reference to the reference line KL.

The first flow path forming member 10A is a flow path forming member 10 with a configuration corresponding to the outlet region Ro in the heat pump module 1. The first flow path forming member 10A includes the first connector 15A, the second connector 15B, the seventh connector 15G, and the eighth connector 15H formed therein, with the high-pressure flow path 11 and the high-temperature heat medium flow path 13 extending from those connectors.

Also, in the first flow path forming member 10A, the slit 16A as the heat transfer suppressor 16 is formed at a position between the high-pressure flow path 11 and the high-temperature heat medium flow path 13. As shown in FIG. 8, the slit 16A is formed (a) at a position between the high-pressure flow path 11 pertaining to the first connector 15A and the high-temperature heat medium flow path 13 pertaining to the seventh connector 15G, and (b) at a position between the high-pressure flow path 11 pertaining to the second connector 15B and the high-temperature heat medium flow path 13 pertaining to the eighth connector 15H, respectively.

Therefore, the slit 16A in the first flow path forming member 10A can suppress heat transfer between the high-pressure flow path 11 and the high-temperature heat medium flow path 13, as in the first embodiment, to prevent heat damage between the high-pressure flow path 11 and the high-temperature heat medium flow path 13.

The second flow path forming member 10B is the flow path forming member 10 with a configuration corresponding to the inlet region Ri in the heat pump module 1. The second flow path forming member 10B has the third connector 15C to the sixth connector 15F and the ninth connector 15I to the twelfth connector 15L formed therein, with the low-pressure flow path 12 and the low-temperature heat medium flow path 14 extending from those connectors.

Further, in the second flow path forming member 10B, the slit 16A as the heat transfer suppressor 16 is formed at a position between the low-pressure flow path 12 and the low-temperature heat medium flow path 14. As shown in FIG. 8, the slit 16A is formed (a) at a position between the low-pressure flow path 12 pertaining to the fifth connector 15E and the low-temperature heat medium flow path 14 pertaining to the eleventh connector 15K, and (b) at a position between the low-pressure flow path 12 pertaining to the sixth connector 15F and the low-temperature heat medium flow path 14 pertaining to the eleventh connector 15K, respectively. Also, the slit 16A is formed (a) at a position between the low-pressure flow path 12 pertaining to the third connector 15C and the low-temperature heat medium flow path 14 pertaining to the twelfth connector 15L, and (b) at a position between the low-pressure flow path 12 pertaining to the fourth connector 15D and the low-temperature heat medium flow path 14 pertaining to the ninth connector 15I, respectively.

Therefore, the slit 16A in the second flow path forming member 10B can suppress heat transfer between the low-pressure flow path 12 and the low-temperature heat medium flow path 14, as in the first embodiment, to prevent heat damage between the low-pressure flow path 12 and the low-temperature heat medium flow path 14.

Here, in the heat pump module 1 of the second embodiment, the first flow path forming member 10A and the second flow path forming member 10B are fixed to the housing 21A of the compressor 21 so that a gap 16B is created therebetween, as shown in FIG. 8. The gap 16B has an air layer with a lower heat transfer coefficient than the constituent materials of the first and second flow path forming members 10A and 10B, interposed between the first and second flow path forming members 10A and 10B. Thus, the gap 16B corresponds to an example of a heat transfer suppressor 16.

In the right end part of the first flow path forming member 10A for the second embodiment, a part of the high-pressure flow path 11 extending from the second connector 15B is arranged, and, in the left end part of the second flow path forming member 10B, a part of the low-temperature heat medium flow path 14 extending from the eleventh connector 15K is arranged. As shown in FIG. 8, the gap 16B as the heat transfer suppressor 16 is arranged at a position between the high-pressure flow path 11 pertaining to the second connector 15B and the low-temperature heat medium flow path 14 pertaining to the eleventh connector 15K.

As described above, with respect to the temperature difference between the fluids in the refrigerant flow path and the heat medium flow path, the temperature difference between the high-pressure refrigerant flowing in the high-pressure flow path 11 and the low-temperature heat medium flowing in the low-temperature heat medium flow path 14 is relatively large. In other words, it is understood that, in terms of heat damage between the refrigerant flow path and the heat medium flow path, heat damage caused between the high-pressure flow path 11 and the low-temperature heat medium flow path 14 has significant influence.

According to the heat pump module 1 of the second embodiment, the gap 16B suppresses heat transfer between the high-pressure flow path 11 and the low-temperature heat medium flow path 14. Therefore, the heat pump module 1 of the second embodiment can reliably prevent the performance degradation of the heat pump cycle 20 and the second low-temperature heat medium circuit 50 due to heat damage.

As explained above, according to the second embodiment, even when the configuration of the flow path forming member 10 is changed and the heat transfer suppressor 16 is provided with the slit 16A and the gap 16B, the same configuration and operation as in the embodiment described above are providable to achieve the same effects.

The present disclosure is not limited to the embodiments described above, and various modifications can be made as follows within a range not departing from the spirit of the present disclosure.

The heat pump module 1 of the embodiment described above was applied to the heat pump system 100 having the heat pump cycle 20, the high-temperature heat medium circuit 30, the first low-temperature heat medium circuit 40, and the second low-temperature heat medium circuit 50, but is not limited to such mode. For example, the circuit configuration of the heat pump cycle 20 in the heat pump system 100 can be changed from the configuration of the embodiment described above. In such case, the flow path configuration in the flow path forming member 10 and the type and arrangement of the component devices attached to the flow path forming member 10 can be changed according to the post-change configuration of the heat pump cycle 20.

The configuration of the high-temperature heat medium circuit 30, the first low-temperature heat medium circuit 40, and the second low-temperature heat medium circuit 50 in the heat pump system 100 to which the heat pump module 1 is applied is also not limited to the embodiment described above. For example, in the embodiments described above, the high-temperature heat medium circuit 30, the first low-temperature heat medium circuit 40, and the second low-temperature heat medium circuit 50 were configured to have heat medium circulating independently of each other, but such configuration is not limiting. That is, at least two of the high-temperature heat medium circuits 30, the first low-temperature heat medium circuit 40, and the second low-temperature heat medium circuit 50 may be connected in such a way that the heat medium can flow in and out.

Also, the components arranged in the high-temperature heat medium circuit 30, the first low-temperature heat medium circuit 40, and the second low-temperature heat medium circuit 50 are not limited to the ones in the above-mentioned embodiments. Depending on the circuit configuration of each of the heat medium circuits, additional components may be added to the heat medium circuit, or components of the heat medium circuit may be modified. For example, in the high-temperature heat medium circuit 30, a high-temperature heat sink and flow control valve may be added in addition to the heater core 32, and heat from the heat medium in the high-temperature heat medium circuit 30, which is surplus heat from heating in the heater core 32, may be dissipated from the high-temperature heat sink.

In the embodiment described above, the heat medium refrigerant heat exchanger 22, the receiver 23, the first expansion valve 25, and the second expansion valve 26 were listed as the high-pressure components in the heat pump module, but the configuration is not limited to such mode. The high-pressure components may be any components into which the high-pressure refrigerant flows in the heat pump cycle 20; in other words, any components in the heat pump cycle 20 arrangeable at a position between the outlet port 21D of the compressor 21 and the inlet port of the decompression unit (e.g., the first expansion valve 25). Various components may be employed as the high-pressure components of the heat pump module 1, as long as they satisfy these conditions.

Further, in the embodiment described above, even though the first chiller 27 and the second chiller 28 were listed as low-pressure components in the heat pump module 1, the configuration is not limited to such mode. The low-pressure components may be any components into which the low-pressure refrigerant flows in the heat pump cycle 20; in other words, any components in the heat pump cycle 20 arrangeable at a position between the outlet port of the decompression unit (e.g., the first expansion valve 25) and the inlet port 21F of the compressor 21. Various components may be employed as the low-pressure components of the heat pump module 1, as long as they satisfy these conditions.

In the embodiments described above, as shown in FIG. 1, and the like, the configuration had an arrangement in which, from top to bottom, the heat medium refrigerant heat exchanger 22, the components such as the first chiller 27 and the like, the flow path forming member 10, and the compressor 21 were arranged in this written order, but the arrangement is not limited to the above. For example, it is possible to adopt a configuration in which the compressor 21, the flow path forming member 10, and each of the components may be arranged in this written order from top to bottom.

In the flow path forming member 10 of the embodiments described above, the heat transfer suppressor 16 was arranged at a position between the high-pressure flow path 11 and the low-temperature heat medium flow path 14, between the high-pressure flow path 11 and the high-temperature heat medium flow path 13, and between the low-pressure flow path 12 and the low-temperature heat medium flow path 14, but the configuration is not limited to such mode.

For example, when the low-pressure flow path 12 and the high-temperature heat medium flow path 13 are adjacent to each other in the flow path arrangement in the flow path forming member 10, the heat transfer suppressor 16 may be arranged at a position between the low-pressure flow path 12 and the high-temperature heat medium flow path 13.

In such manner, heating of the low-pressure refrigerant flowing in the low-pressure flow path 12 by the heat of the high-temperature heat medium flowing in the high-temperature heat medium flow path 13 is prevented, thereby achieving efficient operation of the heat pump cycle 20. In addition, heat from the high-temperature heat medium flowing in the high-temperature heat medium flow path 13 is suppressible from being absorbed by the low-pressure refrigerant flowing in the low-pressure flow path 12, thereby reducing the loss in heat transfer by the high-temperature heat medium.

Further, the configuration is not limited to the one, in which the heat transfer suppressor 16 is arranged at multiple positions, among the position between the high-pressure flow path 11 and the low-temperature heat medium flow path 14, the position between the low-pressure flow path 12 and the high-temperature heat medium flow path 13, the position between the high-pressure flow path 11 and the high-temperature heat medium flow path 13, and the position between the low-pressure flow path 12 and the low-temperature heat medium flow path 14. The heat transfer suppressor 16 may be arranged at at least one of the above-described four modes.

Further, in the embodiments described above, air with a lower heat transfer coefficient than the material constituting the flow path forming member 10 is interposed, as the heat transfer suppressor 16, to suppress heat transfer between the refrigerant flow path and the heat medium flow path. However, such configuration is not a limiting one. For example, a filler of the internal space in the slit 16A is not limited to air, but may also be various materials as long as the material has a lower heat transfer coefficient than the material comprising the flow path forming member 10.

Although the present disclosure has been made in accordance with the embodiments, it is understood that the present disclosure is not limited to such embodiments and structures. The present disclosure includes various changes and modifications within an equivalent range. In addition, the various other combinations and configurations, which may have only a single additional element added thereto, more than that, or less than, are also within the spirit and scope of the present disclosure.

What is claimed is:

1. A heat pump module comprising:
a compressor configured to compress and discharge refrigerant;
a component being a part of a heat pump cycle and configured to cause refrigerant, which is discharged from the compressor, to flow therethrough; and
a flow path forming member to which the compressor and the component are attached, the flow path forming member defining
a refrigerant flow path configured to cause refrigerant to flow between the refrigerant flow path and at least one of the compressor or the component, and
a heat medium flow path configured to cause heat medium to flow therethrough and to exchange heat with refrigerant in the component, wherein
the flow path forming member includes
a high-temperature flow path being one of the refrigerant flow path and the heat medium flow path and configured to cause refrigerant or heat medium, which exhibits high temperature due to heat of high-pressure refrigerant, to flow therethrough,
a low-temperature flow path being one of the refrigerant flow path and the heat medium flow path and configured to cause refrigerant or heat medium, which exhibits temperature lower than temperature in the high-temperature flow path, to flow therethrough, and
a heat transfer suppressor configured to suppress transfer of heat between the refrigerant flow path and the heat medium flow path.

2. The heat pump module according to claim 1, wherein
the high-temperature flow path includes
a high-temperature refrigerant flow path configured to cause high-pressure refrigerant to flow therethrough, and
a high-temperature heat medium flow path configured to cause heat medium, which is heated due to heat exchange with high-pressure refrigerant, to flow therethrough,
the low-temperature flow path includes
a low-temperature refrigerant flow path configured to cause low-pressure refrigerant to flow therethrough, and
a low-temperature heat medium flow path configured to cause heat medium, which exhibits temperature lower than temperature in the high-temperature heat medium flow path due to heat exchange with low-pressure refrigerant, to flow therethrough, and
the heat transfer suppressor is configured to suppress transfer of heat between the refrigerant flow path and the heat medium flow path at at least one of
a position between the high-temperature refrigerant flow path and the low-temperature heat medium flow path,
a position between the low-temperature refrigerant flow path and the high-temperature heat medium flow path,
a position between the high-temperature refrigerant flow path and the high-temperature heat medium flow path, or
a position between the low-temperature refrigerant flow path and the low-temperature heat medium flow path.

3. The heat pump module according to claim 1, wherein
the high-temperature flow path includes a high-temperature refrigerant flow path configured to cause high-pressure refrigerant to flow therethrough,
the low-temperature flow path includes a low-temperature heat medium flow path configured to cause heat medium, which exhibits temperature lower than temperature in the high-temperature flow path due to heat exchange with low-pressure refrigerant, to flow therethrough, and
the heat transfer suppressor is configured to suppress transfer of heat between the high-temperature refrigerant flow path and the low-temperature heat medium flow path.
